(19) United States
(12) Patent Application Publication
(10) Pub. No.: US 2008/0056303 A1
(43) Pub. Date: Mar. 6, 2008

(54) Method and apparatus for fast or negative acknowledgement in a mobile communication system

(75) Inventors: Guillaume Sebire, Espoo (FI); David Navratil, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/893,382

(22) Filed: Aug. 14, 2007

Related U.S. Application Data
(60) Provisional application No. 60/841,649, filed on Aug. 30, 2006.

(51) Int. Cl. H04J 3/24

(52) U.S. Cl. 370/474

(57) ABSTRACT

A method and apparatus are provided to determine whether to include acknowledgement information within radio link control/medium access control (RLC/MAC) data transfer blocks. If the acknowledgement information is to be included in the data transfer blocks it may have a variable length. The acknowledgement information may also be encoded independently of all other parts of the RLC/MAC data transfer block.

### CROSS REFERENCE TO RELATED APPLICATIONS

This application claims the benefit of U.S. Provisional Application No. 60/841,649, filed Aug. 30, 2006 under 35 U.S.C. §119(e).

### BACKGROUND OF THE INVENTION

1. Technical Field

The present invention relates to cooperation between elements of a communication system. More specifically, the present invention relates to the inclusion of acknowledgement information in data transfer blocks.

2. Discussion of related art

In Enhanced General Packet Radio Service (EGPRS), a radio link control (RLC) transmitter relies on a RLC receiver to provide information about received/missing data blocks RLC acknowledged mode and RLC non-persistent mode. The RLC receiver reports an acknowledgement status of its RLC receive window to the RLC transmitter through a received block bitmap carried in (EGPRS) PACKET UPLINK/DOWNLINK ACK/NACK control message, as discussed in 3 GPP TS 44.060, Technical Specification Group GSM/EDGE Radio Access Network; General Packet Radio Service (GPRS); Mobile Station (MS)-Base Station System (BSS) interface; Radio Link Control/Medium Access Control (RLC/MAC) protocol (Release 7)(2005-07), which is hereby incorporated by reference in its entirety. The ACK/NACK control message indicates which data packets were successfully received, and which need to be retransmitted by the RLC transmitter. However, a ACK/NACK control message cannot be sent for each RLC data block as this would otherwise result in an unacceptable overhead. Instead the ACK/NACK message is sent by the RLC receiver, which may be for example a mobile station (MS), upon reception of a poll from the RLC transmitter in case of downlink data transfer. The RLC receiver, which may be for example a base station system (BSS), determines itself when to send the ACK/NACK message in case of uplink data transfer. Consequently, the delay between an initial transmission and a retransmission of data blocks is partly a function of the frequency with which the reports are provided. This may result in too large delays or adversely too large overhead for time sensitive applications.

What is needed is a system to improve Ack/Nack reporting in order to minimize the delay between an initial transmission and a retransmission without unduly increasing overhead.

### SUMMARY OF THE INVENTION

In order to overcome the problems discussed above, a short received block bitmap may be included within radio link control/medium access control (RLC/MAC) blocks for data transfer: the inclusion of the ack/nack information within RLC/MAC blocks for data transfer is referred to in this document as piggy-backed ack/nack information (PAN). The Ack/Nack field included within the RLC/MAC blocks may have a variable length (variable ack/nack bitmap size). The variable length allows to insert as short a bitmap as necessary thus providing more space in the RLC/MAC block for blocks containing data, which allows a better channel coding of the data part as opposed to the case when the PAN length is fixed. The Ack/Nack field may be encoded independently of all other parts of the RLC/MAC block. The independently coded PAN can be protected by a more robust channel coding than the data part.

In a first aspect of the invention a method is provided, comprising, determining whether to include acknowledgement information in a data transfer block, and including the acknowledgement information in the data transfer block if it is determined that the acknowledgement information should be included, wherein the acknowledgement information may comprise a variable length acknowledgement bitmap.

In accord with the first aspect of the invention, the acknowledgement information may be encoded independently of the data transfer block.

In accord with the first aspect of the invention, the data transfer block may comprise at least one data block.

In accord with the first aspect of the invention, the data transfer block may comprise a header comprising protocol information.

In accord with the first aspect of the invention, the header may indicate the presence of the acknowledgement information.

In accord with the first aspect of the invention, the header may indicate the length of the acknowledgement information.

In accord with the first aspect of the invention, the acknowledgement information may comprise an address identifying the temporary block flow to which the acknowledgement information refers.

In accord with the first aspect of the invention, the acknowledgement information may comprise a starting sequence number.

In accord with the first aspect of the invention, if the acknowledgement information is 21 bits or less, a coding rate between 0.37 and 0.97 may be used for the at least one data block.

In accord with the first aspect of the invention, if the acknowledgement information is greater than 21 bits, a coding rate between 0.39 and 1 may be used for the at least one data block.

In accord with the first aspect of the invention, a coding rate between 0.33 and 0.63 may be used for the acknowledgement information.

In accord with the first aspect of the invention, a coding rate between 0.36 and 0.57 may be used if the header is included in a downlink channel.

In accord with the first aspect of the invention, a coding rate between 0.33 and 0.51 may be used if the header is included in an uplink channel.

In accord with the first aspect of the invention, a computer program product comprising a computer readable storage structure embodying computer program code thereon for execution by a computer processor is provided, wherein the computer program code comprises instructions for performing the method according to the first aspect of the invention.

In accord with a second aspect of the invention, an apparatus is provided, comprising a processor configured to determine whether to include acknowledgement information in a data transfer block, and a module configured to include the acknowledgement information in the data transfer block based on the determination by the processor, wherein the acknowledgement information comprises a variable length acknowledgement bitmap.

In accord with the second aspect of the invention, the acknowledgement information may be encoded independently of the data transfer block.

In accord with the second aspect of the invention, the data transfer block may comprise at least one data block.

In accord with the second aspect of the invention, the data transfer block may comprise a header comprising protocol information.

In accord with the second aspect of the invention, the header may indicate the presence of the acknowledgement information.

In accord with the second aspect of the invention, the header may indicate the length of the acknowledgement information.

In accord with the second aspect of the invention, the acknowledgement information may comprise an address identifying the temporary block flow to which the acknowledgement information refers.

In accord with the second aspect of the invention, the acknowledgement information may comprise a starting sequence number.

In accord with the second aspect of the invention, when the acknowledgement information is 21 bits or less, a coding rate between 0.37 and 0.97 may be used for the at least one data block.

In accord with the second aspect of the invention, when the acknowledgement information is greater than 21 bits, a coding rate between 0.39 and 1 may be used for the at least one data block.

In accord with the second aspect of the invention, a coding rate between 0.33 and 0.63 may be used for the acknowledgement information.

In accord with the second aspect of the invention, a coding rate between 0.36 and 0.57 may be used when the header is included in a downlink channel.

In accord with the second aspect of the invention, a coding rate between 0.33 and 0.51 may be used when the header is included in an uplink channel.

In accord with a third aspect of the invention, an apparatus is provided, comprising means for determining whether to include acknowledgement information in a data transfer block, and means for including the acknowledgement information in the data transfer block based on the determination by the means for determining, wherein the acknowledgement information may comprise a variable length acknowledgement bitmap.

In accord with a fourth aspect of the invention, a system is provided, comprising a receiving entity, and a transmitting entity, wherein the receiving entity or the transmitting entity are configured to include acknowledgement information comprising a variable length acknowledgement bitmap in a data transfer block.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a data transfer block including an Ack/Nack field.

FIGS. 2a, 2b, and 2c are header formats containing information indicating the presence and length of an Ack/Nack field.

FIGS. 3a, 3b, and 3c are header formats containing information indicating the presence and length of an Ack/Nack field.

FIGS. 4a, 4b, and 4c are header formats containing information indicating the presence and length of an Ack/Nack field.

FIG. 5 shows the channel coding process of a data transfer block containing an Ack/Nack field FIG. 6 is a block diagram/ flow diagram of a wireless communication system in which the present invention may be implemented, including various communication terminals.

FIG. 7 is a reduced block diagram of two communications terminals of FIG. 6 in terms of a multi-layered communication protocol stack.

FIG. 8 is a reduced block diagram of a communication terminal according to an aspect of the present invention.

FIG. 9 is a flow diagram showing a method according to an aspect of the present invention.

### DETAILED DESCRIPTION OF THE INVENTION

The invention involves or is related to cooperation between elements of a wireless communication system. Examples of a wireless communication system include implementations of GSM (Global System for Mobile Communication) and implementations of UMTS (Universal Mobile Telecommunication System). Each such wireless communication system includes a radio access network (RAN). A GSM RAN includes one or more base station controllers (BSCs), each controlling one or more base transceiver stations (BTSs). The combination of a BSC and the BTSs it controls is called a base station system (BSS).

Referring now to FIG. 6, a wireless communication system 67 in which the present invention may be implemented is shown, including a mobile terminal 61, a radio access network 68, a core network 64 and a gateway 65, coupled via the gateway to another communications system 66, such as the Internet, wireline communication systems (including the so-called plain old telephone system), and/or other wireless communication systems. The radio access network includes a wireless terminal 62 (e.g. a Node B or a BTS) and a controller 63 (e.g. a RNC or a BSC). The controller is in wireline communication with the core network. The core network typically includes a mobile switching center (MSC) for circuit-switched communication, and a serving general packet radio service (GPRS) support node (SGSN) for packet-switched communication.

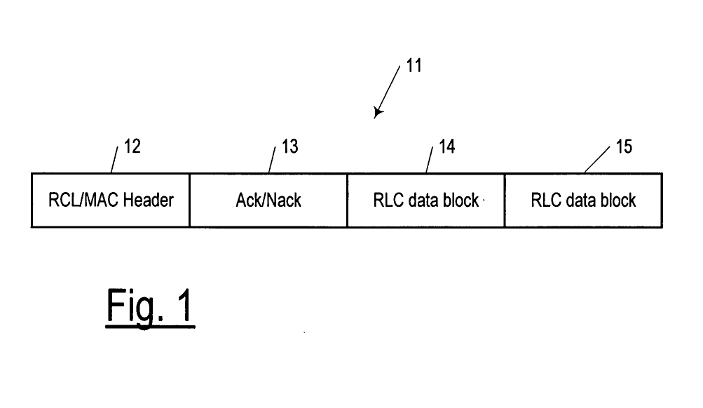

FIG. 1 shows inclusion of acknowledgement information in the form of an acknowledgement/negative acknowledgement field (Ack/Nack) 13 in a radio link control/medium access control (RLC/MAC) data transfer block 11. The acknowledgement information provides an indication as to whether particular data packets were successfully received by a receiving entity. Therefore, an acknowledgement indicates that data packets were successfully received, while a negative acknowledgement indicates that the data packets were not successfully received. The data transfer block 11 may also include a header field 12, and a data block 14. The data transfer block 11 may also include a second data block 15.

The inclusion of the acknowledgement information 13 in the data transfer block 11 may be optional, and the decision whether to include the acknowledgement information 13 may be based on different policies employed during transmission. The decision whether or not to include acknowledgement information may be made by the radio link control (RLC) entity which will send the acknowledgement information, i.e. the radio link control receiver, such as a mobile station (MS). For example, during a reliable mode of operation the acknowledgement information may be included in each RLC/MAC data transfer block. This will ensure that the RLC transmitter has up-to-date information regarding the state of the receive window at the RLC receiver. In another exemplary embodiment of the invention, the dynamicity of state of the receive window is taken into consideration, and the RLC receiver may insert the acknowledgement information in consecutive RLC/MAC data transfer blocks after it has been decided to include acknowledgement information. The decision whether or not to include acknowledgement information may also be made by the radio link control (RLC) entity which sends the data, i.e. the radio link control transmitter such as a base station system (BSS). In this case, the RLC transmitter upon decision to receive acknowledgement information polls the RLC receiver to send this information.

The acknowledgement information, i.e. Ack/Nack field or piggy-backed ack/nack information (PAN), may contain an address, a starting sequence number, and a bitmap. It is understood that the terms Ack/Nack field and PAN are interchangeable, and both refer to acknowledgement information. The address may be from zero to five bits in length, and provides a unique identification of the temporary block flow (TBF) that is being acknowledged by the Ack/Nack field. The address field may be either mandatory or optional. If the address field is optional, in one embodiment of the invention it will not be included when a RLC receiver, such as a mobile station (MS), only has a single temporary block flow running in the radio link control acknowledged mode, or radio link control non-persistent mode assigned in the opposite direction. The address field may be included when the mobile station has more than one temporary block flow in the opposite direction running in the radio link control acknowledged mode or radio link control non-persistent mode. In one embodiment, the address field may be defined as a temporary flow identity (TFI) sequence number of all the temporary flow identities allocated to the mobile station in the opposite direction, sorted in ascending order. In another embodiment, the address field may be defined as the actual temporary flow identity of the temporary block flow being acknowledged. In another embodiment, the address field may be defined to contain also a timeslot number, and possibly a carrier number in case of dual or multi carrier transmission is used, on which the acknowledged temporary block flow is assigned.

The Ack/Nack field or PAN 13 may also contain a starting sequence number which may indicate to a base station or Node B, for example, the oldest data block not yet received. The starting sequence number may be eleven bits in length, and may be encoded as the actual starting sequence number, or by the least significant bit or bits of the actual starting sequence number.

The Ack/Nack field or PAN 13 may also contain a bitmap which may indicate either an acknowledgement, meaning that a particular data packet was successfully received, or a negative acknowledgement. In one embodiment of the invention, 0 may be used to indicate negative acknowledgement, and 1 may be used to indicate acknowledgement. The bitmap may be of a variable length, and its length may be dependent on the total length of the Ack/Nack field 13. The decision about the length of the Ack/Nack field 13 to be included in the RLC/MAC data transfer block may be based on factors such as bitmap length, robustness of data part coding, dynamicity of state for the receive window, as well as other factors.

If an Ack/Nack field or PAN 13 is included in the data transfer block 11, the header 12 may include an indication that the Ack/Nack field 13 is included, and the same indication or another indication in the header 12 may provide information regarding the Ack/Nack field 13 length.

Tables 1 and 2 provide an example of how fields within the header 12 can be used to indicate when an Ack/Nack field is included in a data transfer block and the length of the Ack/Nack field. Tables 1 and 2 demonstrate using EGPRS supplementary/polling (ES/P) and relative reserved block period (RRBP) fields to indicate whether the Ack/Nack field is included, and its length in a downlink header.

TABLE 1
EGPRS Supplementary/Polling (ES/P) field (non-MBMS only)

| Bits (5 4) | ES/P |
|---|---|
| 0 0 | Indicates Ack/Nack field information occurrence |
| | and length |
| 0 1 | RRBP field is valid - Extended Ack/Nack field |
| | bitmap type FPB |
| 1 0 | RRBP field is valid - Extended Ack/Nack field |
| | bitmap type NPB |
| 1 1 | RRBP field is valid - Ack/Nack field bitmap type |
| | NPB, measurement report included |

Table 2 indicates the relative reserve block period value if EGPRS Supplementary/Polling (ES/P) is “0 0,” as shown in Table 1.

TABLE 2
Relative Reserved Block Period (RRBP) field indicating the
occurrence and length of Ack/Nack field.

| Bit (6 5) | Ack/Nack field length (bits) |
|---|---|
| 0 0 | No Ack/Nack field |
| 0 1 | 21 |
| 1 0 | 29 (bitmap length of 13 to 18 bits, or 13 bits) |
| 1 1 | 37 (bitmap length of 21 to 26 bits, or 21 bits) |

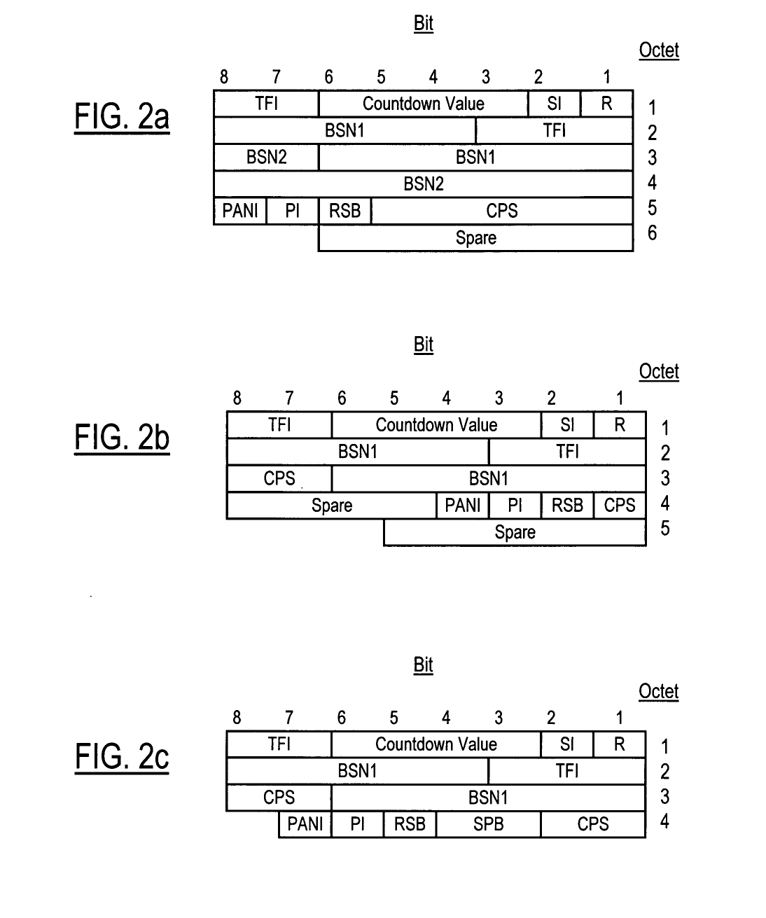

FIGS. 2a through 2c demonstrate how the presence of an Ack/Nack field, and its length can be indicated in an uplink header according to an exemplary embodiment of the invention. FIG. 2a shows the format for an uplink header for modulation and coding schemes 7, 8 and 9 according to an exemplary embodiment of the invention. FIG. 2b shows the format for an uplink header for modulation and coding schemes 5 and 6. FIG. 2c shows the format for an uplink header for modulation and coding schemes 1, 2, 3 and 4. In accordance with an embodiment of the invention each header format may include an indication relating to the Ack/Nack (PANI). The Resent Block Bit (RSB) may also be redefined to also provide information relating to the Ack/Nack field, i.e. its presence and/or length.

Table 3 provides an example of how the bits relating to the RSB and PANI may be used to provide information relating to the Ack/Nack field.

TABLE 3
Interpretation of RSB and PANI

| RSB | PANI | Ack/Nack field occurrence and length |
|---|---|---|
| 0 | 0 | No Ack/Nack field |
| 0 | 1 | Ack/Nack field of 21 bits |
| 1 | 0 | Ack/Nack field of 29 bits |
| 1 | 1 | Ack/Nack field of 37 bits |

In another exemplary embodiment of the invention, the header may include a separate field (PANI) which may specify the occurrence and length of the Ack/Nack field. Table 4 shows an exemplary embodiment in which three bits are used to provide the Ack/Nack indication. It is understood that any number of bits less than or greater than three can be used to specify the length and occurrence of the Ack/Nack field. In addition, the lengths of the Ack/Nack field are not limited to the bit information listed in Table 4, as it is possible that the lengths can be indicated by other bit information than those listed in Table 4. The lengths of the Ack/Nack fields are examples of possible lengths, and it is contemplated that other bit lengths could be used for the Ack/Nack field.

TABLE 4
Ack/Nack indication bits

| bits | Ack/Nack occurrence and length |
|---|---|
| 000 | No Ack/Nack field |
| 001 | 21 bit Ack/Nack field |
| 010 | 29 bit Ack/Nack field |
| 011 | 37 bit Ack/Nack field |
| 100 | 45 bit Ack/Nack field |

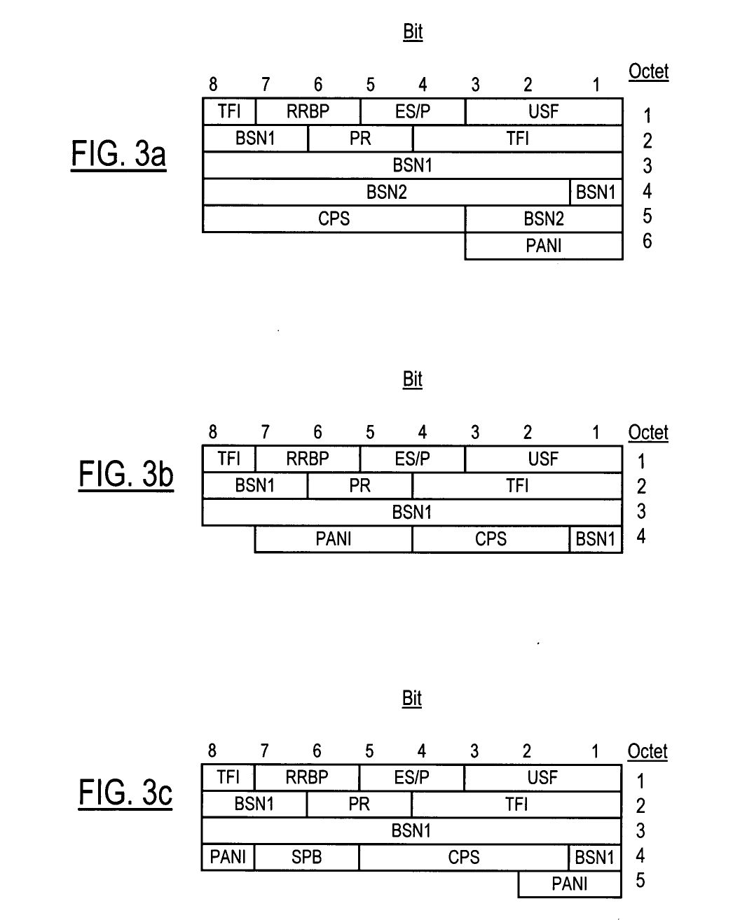

The addition of a separate field to the header may increase the length of the downlink header, which may affect the coding rates for all parts of the data transfer block. FIGS. 3a through 3c provide exemplary embodiments for three downlink header types when a separate field (PANI) of three bits is used in the downlink header to indicate length and occurrence of the Ack/Nack field.

FIG. 3a represents a downlink header that may be used when there are two data blocks in the data transfer block, and 8 Phase Shift Keying (8PSK) modulation is used.

FIG. 3b represents a downlink header that may be used when there is one data block in the data transfer block, and 8PSK modulation is used.

FIG. 3c represents a downlink header that may be used when there is one data block in the data transfer block, and Gaussian minimum shift keying (GMSK) modulation is used. It is understood that other downlink header formats are possible.

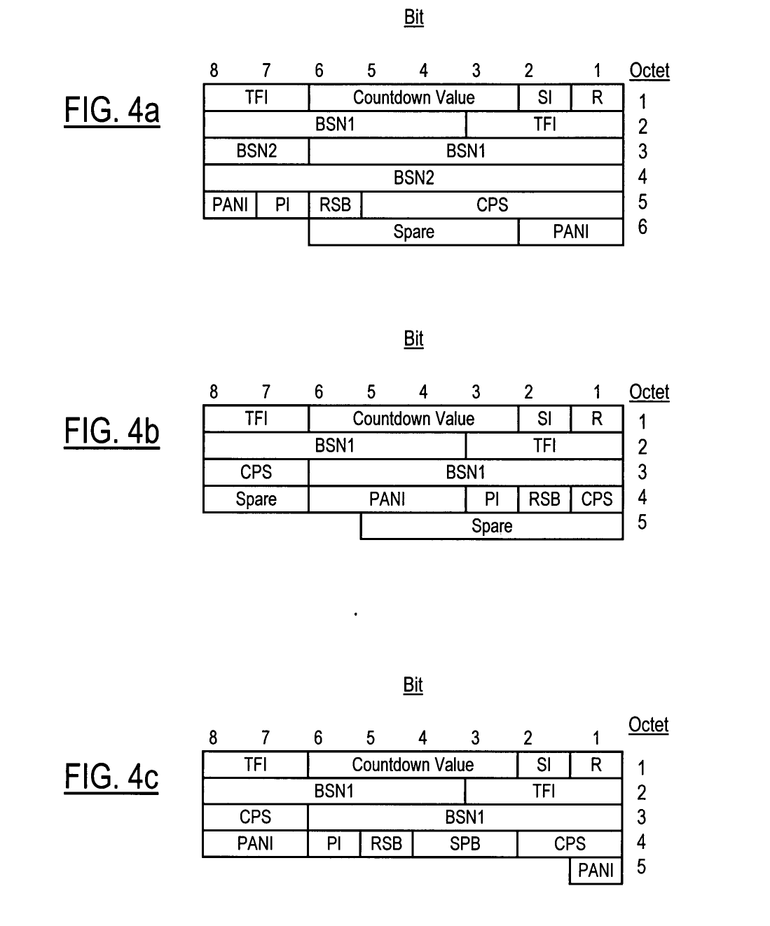

FIGS. 4a through 4c provide exemplary embodiments for three uplink header types when a separate field (PANI) of three bits is used in the uplink header to indicate length and occurrence of the Ack/Nack field.

FIG. 4a represents an uplink header that may be used when there are two data blocks in the data transfer block, and 8PSK modulation is used. The uplink header shown in FIG. 4a may be suitable for modulation and coding schemes 7, 8 and 9, as well as other modulation and coding schemes.

FIG. 4b represents an uplink header that may be used when there is one data block in the data transfer block and 8PSK modulation is used. The uplink header shown in FIG. 4b may be suitable for modulation and coding schemes 5 and 6, as well as other modulation and coding schemes.

FIG. 4c represents an uplink header that may be used when there is one data block in the data transfer block and GMSK modulation is used. The uplink header shown in FIG. 4c may be suitable for modulation and coding schemes 1, 2, 3 and 4, as well as other modulation and coding schemes.

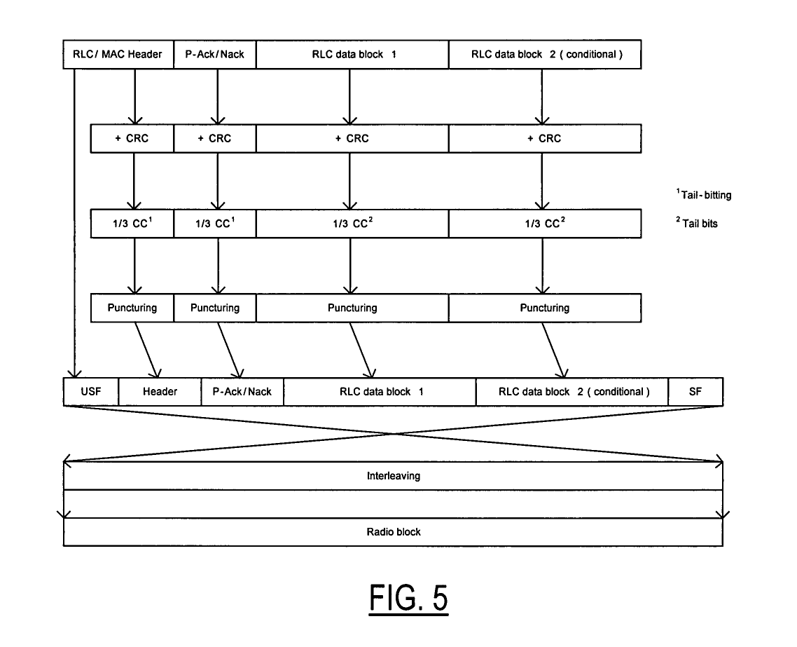

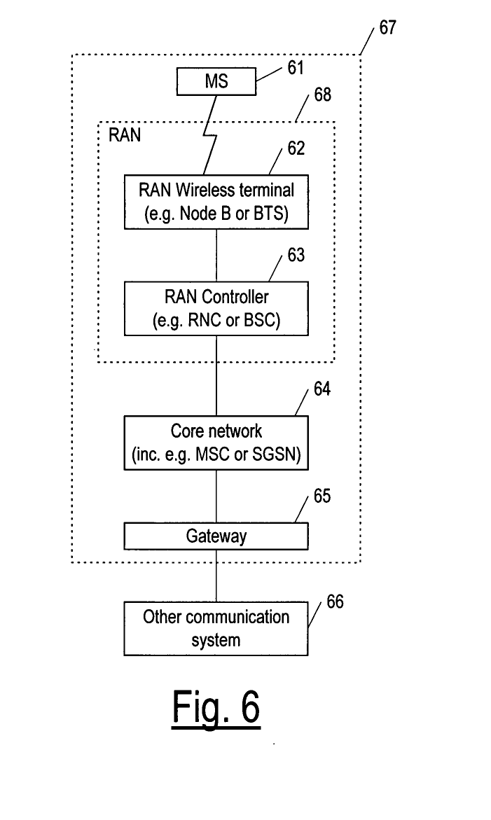

FIG. 5 depicts the channel coding process for data transfer blocks including the Ack/Nack field. FIG. 5 is representative of the downlink direction, but it is understood that the channel coding process may be similar in the uplink direction, except that there is no uplink stage flag (USF). The Ack/Nack field may first be protected by short cyclic redundancy check (CRC), for example using three bits. For example, three parity bits may be added to the Ack/Nack field delivered to an encoder. The last six Ack/Nack field bits may be added before the information and parity bits, i.e. tail biting. The Ack/Nack field may then be encoded with its CRC with the same 1/3-rate convolutional code as may be used for the header. The header and Ack/Nack field may be punctured according to puncturing matrices or puncturing schemes. In an exemplary embodiment of the invention Flexible Layer One (FLO) puncturing formula as defined in 3GPP TS 45.003 3^{rd} Generation Partnership Project; Technical Specification Group GSM/EDGE Radio Access Network; Channel Coding, which is hereby incorporated by reference in its entirety, may be used for puncturing the data blocks of the data transfer block.

In an exemplary embodiment of the invention USF coding may be performed separately from the header encoding, and may not change even if the header coding changes.

It is possible that the Ack/Nack field length varies between an initial transmission and a retransmission of a data transfer block. Therefore, it may be desirable to vary the encoding rate of the data transfer block between the initial transmission and the retransmission in order to keep the actual (un-coded) data unchanged and therefore preserve the possibility for soft-combining in the receiver, and also to keep the Ack/Nack field robustly encoded. It may also be desirable to reuse the puncturing formula from FLO definition, which may also provide the possibility of incremental redundancy based on the redundancy pattern index.

Table 5 lists modulating and coding scheme families according to an exemplary embodiment of the invention. The payload for the modulation and coding schemes is reduced due to the insertion of the Ack/Nack field. The payload lengths are listed in Table 5 together with the families.

Tables 6 through 9 list coding rates for the header, Ack/Nack field and data blocks that may be used according to an exemplary embodiment of the invention. Tables 6 and 7 show the coding rates when the Ack/Nack field has a length of 37 bits. Tables 8 and 9 show the coding rates for 21 bit length Ack/Nack field.

TABLE 5
Modulation and Coding Schemes (MCS)

| MCS | Total (bytes) | Data rate (kbps) | Family |
|---|---|---|---|
| 1 | 18 | 7.2 | C |
| 2 | 26 | 10.4 | B |
| 3 | 34 | 13.6 | A |
| 4 | 36 | 14.4 | C |
| 5 | 52 | 20.8 | B |
| 6 | 68 | 27.2 | A |
| 7 | 104 | 41.6 | B |
| 8 | 124 | 49.6 | A-padding |
| 9 | 136 | 54.4 | A |

TABLE 6
Coding Rates for Downlink Data Transfer Block with 37 bit
Ack/Nack Field

| MCS | Header | Ack/Nack Field | Data Block |
|---|---|---|---|
| 1 | 0.53 | 0.63 | 0.53 |
| 2 | 0.53 | 0.63 | 0.74 |
| 3 | 0.53 | 0.63 | 0.95 |
| 4 | 0.53 | 0.63 | 1.00 |
| 5 | 0.33 | 0.33 | 0.39 |
| 6 | 0.33 | 0.33 | 0.50 |
| 7 | 0.36 | 0.42 | 0.77 |
| 8 | 0.36 | 0.42 | 0.91 |
| 9 | 0.36 | 0.42 | 1.00 |

TABLE 7
Coding Rates for Uplink Data Transfer Block with 37 bit
Ack/Nack Field

| MCS | Header | Ack/Nack Field | Data Block |
|---|---|---|---|
| 1 | 0.49 | 0.63 | 0.53 |
| 2 | 0.49 | 0.63 | 0.74 |
| 3 | 0.49 | 0.63 | 0.95 |
| 4 | 0.49 | 0.63 | 1.00 |
| 5 | 0.33 | 0.33 | 0.39 |
| 6 | 0.33 | 0.33 | 0.50 |
| 7 | 0.34 | 0.42 | 0.77 |
| 8 | 0.34 | 0.42 | 0.91 |
| 9 | 0.34 | 0.42 | 1.00 |

TABLE 8
Coding Rates for Downlink Data Transfer Block with 21 bit
Ack/Nack Field

| MCS | Header | Ack/Nack Field | Data Block |
|---|---|---|---|
| 1 | 0.53 | 0.63 | 0.49 |
| 2 | 0.53 | 0.63 | 0.68 |
| 3 | 0.53 | 0.63 | 0.87 |
| 4 | 0.53 | 0.63 | 0.92 |
| 5 | 0.33 | 0.33 | 0.37 |
| 6 | 0.33 | 0.33 | 0.48 |
| 7 | 0.36 | 0.42 | 0.75 |
| 8 | 0.36 | 0.42 | 0.88 |
| 9 | 0.36 | 0.42 | 0.97 |

TABLE 9
Coding Rates for Uplink Data Transfer Block with 21 bit
Ack/Nack Field

| MCS | Header | Ack/Nack Field | Data Block |
|---|---|---|---|
| 1 | 0.49 | 0.63 | 0.49 |
| 2 | 0.49 | 0.63 | 0.68 |
| 3 | 0.49 | 0.63 | 0.87 |
| 4 | 0.49 | 0.63 | 0.92 |
| 5 | 0.33 | 0.33 | 0.37 |
| 6 | 0.33 | 0.33 | 0.48 |
| 7 | 0.34 | 0.42 | 0.75 |
| 8 | 0.34 | 0.42 | 0.88 |
| 9 | 0.34 | 0.42 | 0.97 |

Tables 10 through 13 show coding rates for the header, Ack/Nack field, and data block of the data transfer block according to another exemplary embodiment of the invention.

TABLE 10
Coding Rates for Downlink Data Transfer Block with 37 bit
Ack/Nack Field

| MCS | Header | Ack/Nack Field | Data Block |
|---|---|---|---|
| 1 | 0.57 | 0.63 | 0.53 |
| 2 | 0.57 | 0.63 | 0.74 |
| 3 | 0.57 | 0.63 | 0.95 |
| 4 | 0.57 | 0.63 | 1.00 |
| 5 | 0.36 | 0.33 | 0.39 |
| 6 | 0.36 | 0.33 | 0.50 |
| 7 | 0.39 | 0.42 | 0.77 |
| 8 | 0.39 | 0.42 | 0.91 |
| 9 | 0.39 | 0.42 | 1.00 |

TABLE 11
Coding Rates for Uplink Data Transfer Block with 37 bit
Ack/Nack Field

| MCS | Header | Ack/Nack Field | Data Block |
|---|---|---|---|
| 1 | 0.51 | 0.63 | 0.53 |
| 2 | 0.51 | 0.63 | 0.74 |
| 3 | 0.51 | 0.63 | 0.95 |
| 4 | 0.51 | 0.63 | 1.00 |
| 5 | 0.33 | 0.33 | 0.39 |
| 6 | 0.33 | 0.33 | 0.50 |
| 7 | 0.34 | 0.42 | 0.77 |
| 8 | 0.34 | 0.42 | 0.91 |
| 9 | 0.34 | 0.42 | 1.00 |

TABLE 12
Coding Rates for Downlink Data Transfer Block with 21 bit
Ack/Nack Field

| MCS | Header | Ack/Nack Field | Data Block |
|---|---|---|---|
| 1 | 0.57 | 0.63 | 0.49 |
| 2 | 0.57 | 0.63 | 0.68 |
| 3 | 0.57 | 0.63 | 0.87 |
| 4 | 0.57 | 0.63 | 0.92 |
| 5 | 0.36 | 0.33 | 0.37 |
| 6 | 0.36 | 0.33 | 0.48 |
| 7 | 0.39 | 0.42 | 0.75 |
| 8 | 0.39 | 0.42 | 0.88 |
| 9 | 0.39 | 0.42 | 0.97 |

TABLE 13
Coding Rates for Uplink Data Transfer Block with 21 bit
Ack/Nack Field

| MCS | Header | Ack/Nack Field | Data Block |
|---|---|---|---|
| 1 | 0.51 | 0.63 | 0.49 |
| 2 | 0.51 | 0.63 | 0.68 |
| 3 | 0.51 | 0.63 | 0.87 |
| 4 | 0.51 | 0.63 | 0.92 |
| 5 | 0.33 | 0.33 | 0.37 |
| 6 | 0.33 | 0.33 | 0.48 |
| 7 | 0.34 | 0.42 | 0.75 |
| 8 | 0.34 | 0.42 | 0.88 |
| 9 | 0.34 | 0.42 | 0.97 |

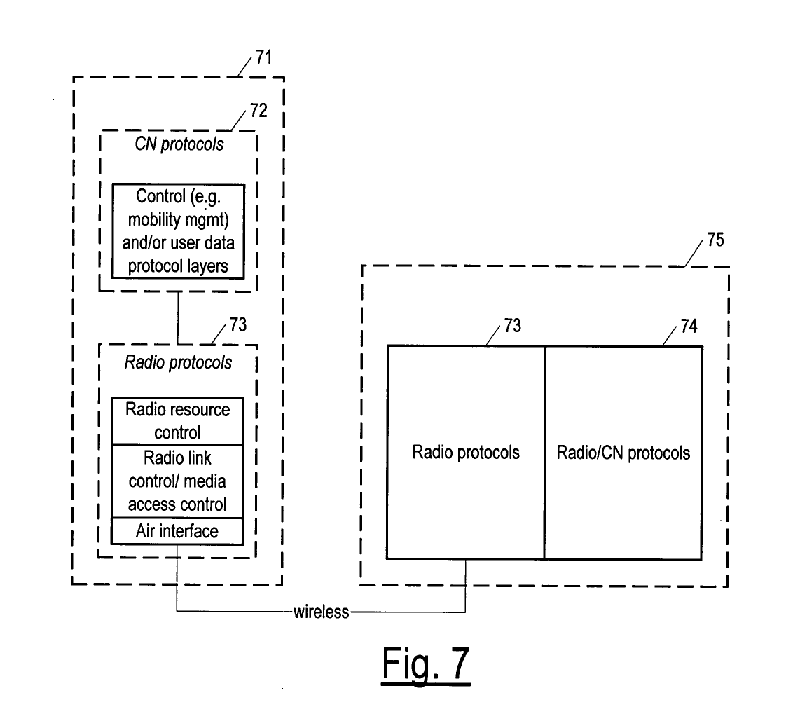

Referring now to FIG. 7, the wireless communication system of FIG. 6 is shown from the perspective of layers of a protocol according to which communication may be performed in accordance with an exemplary embodiment of the invention. The layers of protocol form a protocol stack, and include CN protocol layers 72 located in RLC receiver 71 and a RLC transmitter 75, and radio protocol layers 73 located in the RLC receiver 71 and in the RLC transmitter 75. Communication is peer-to-peer. Thus, a CN protocol layer in the receiver 71 communicates with a corresponding layer in the transmitter 75, and vice versa, and the communication is provided via lower/intervening layers. The lower/intervening layers thus provide as a service to the layer immediately above them in the protocol stack the packaging or unpackaging of a unit of communication (a control signal or user data).

The CN protocols typically include one or more control protocol layers and/or user data protocol layers (e.g. an application layer, i.e. the layer of the protocol stack that interfaces directly with applications, such as a calendar application or a game application).

The radio protocols typically include a radio resource control (protocol) layer, which has as its responsibilities, among quite a few others, the establishment, reconfiguration, and release of radio bearers. Another radio protocol layer is a radio link control/ media access control layer (RLC/MAC) (which may exist as two separate layers). This layer in effect provides an interface with the physical layer, another of the radio access protocol layers, and the layer that enables actual communication over the air interface.

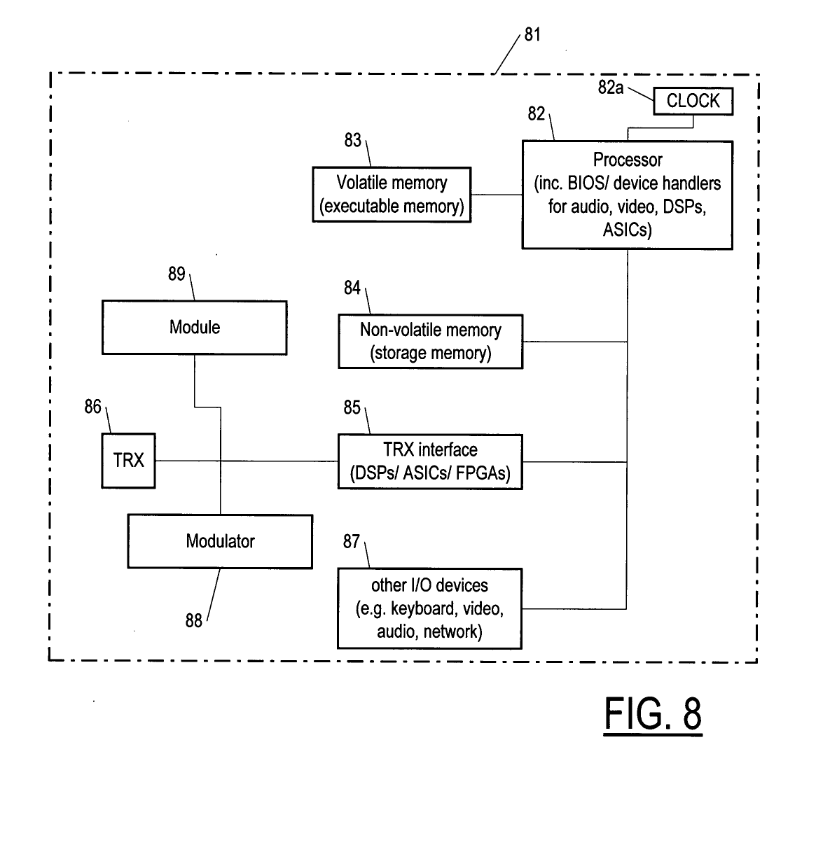

FIG. 8 shows some components of a communication terminal 81, which could be either the RLC receiver 71 or the RLC transmitter 75 of FIG. 7. The communication terminal includes a processor 82 for controlling operation of the device, including all input and output. In an exemplary embodiment of the invention, the processor 82 is configured to determine whether to include acknowledgement information in a RLC/MAC data transfer block. If the processor determines that the acknowledgement information should be included, a module 89 includes the acknowledgement information in the RLC/MAC data transfer block. If necessary, a modulator 88 performs the necessary modulation for the acknowledgement information to be included in the data transfer block, as well as the modulation for the data transfer block, including the header.

The processor, whose speed/timing may be regulated by a clock 82a, and may include a BIOS (basic input/output system) or may include device handlers for controlling user audio and video input and output as well as user input from a keyboard. The BIOS/device handlers may also allow for input from and output to a network interface card. The BIOS and/or device handlers also provide for control of input and output to a transceiver (TRX) 86 via a TRX interface 85 including possibly one or more digital signal processors (DSPs), application specific integrated circuits (ASICs), and/or field programmable gate arrays (FPGAs). The TRX enables communication over the air with another similarly equipped communication terminal.

Still referring to FIG. 8, the communication terminal includes volatile memory, i.e. so-called executable memory 83, and also non-volatile memory 84, i.e. storage memory. The processor 82 may copy applications (e.g. a calendar application or a game) stored in the non-volatile memory into the executable memory for execution. The processor functions according to an operating system, and to do so, the processor may load at least a portion of the operating system from the storage memory to the executable memory in order to activate a corresponding portion of the operating system. Other parts of the operating system, and in particular often at least a portion of the BIOS, may exist in the communication terminal as firmware, and are then not copied into executable memory in order to be executed. The booting up instructions are such a portion of the operating system.

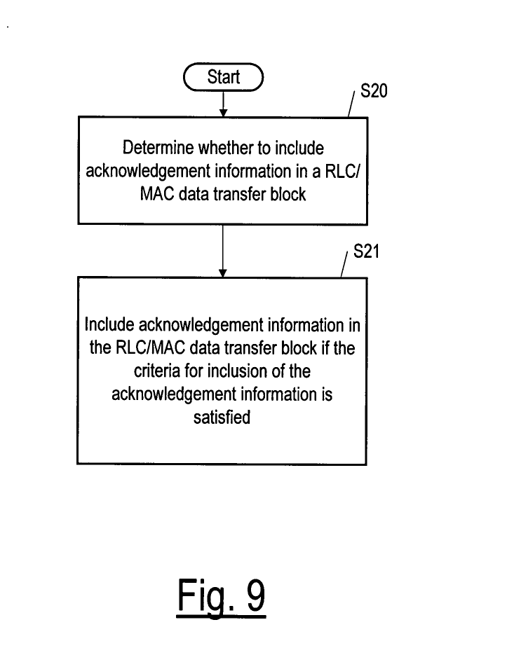

FIG. 9 represents an exemplary embodiment of the invention in which in a step S20 it is determined whether to include acknowledgement information in a RLC/MAC data transfer block. If it is determined that acknowledgement information, i.e. a Ack/Nack field, should be included in the RLC/MAC data transfer block, then the acknowledgement information is included in step S21.

The functionality described above (for both the radio access network and the UE) can be implemented as software modules stored in a non-volatile memory, and executed as needed by a processor, after copying all or part of the software into executable RAM (random access memory). Alternatively, the logic provided by such software can also be provided by an ASIC (application specific integrated circuit). In case of a software implementation, the invention provided as a computer program product including a computer readable storage structure embodying computer program code—i.e. the software—thereon for execution by a computer processor.

It is to be understood that the above-described arrangements are only illustrative of the application of the principles of the present invention. Numerous modifications and alternative arrangements may be devised by those skilled in the art without departing from the scope of the present invention. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. A method, comprising:
including acknowledgement information in a data transfer block, and
encoding the acknowledgement information independently of at least part of the data transfer block.

2. The method according to claim 1, wherein the acknowledgement information comprises a variable length acknowledgement bitmap.

3. The method according to claim 1, wherein the data transfer block comprises at least one data block.

4. The method according to claim 3, wherein the data transfer block comprises a header comprising protocol information.

5. The method according to claim 4, wherein the header indicates the acknowledgement information is included in the data transfer block.

6. The method according to claim 4, wherein the header indicates the length of the acknowledgement information.

7. The method according to claim 1, wherein the acknowledgement information comprises an address identifying a temporary block flow to which the acknowledgement information is related.

8. The method according to claim 1, wherein the acknowledgement information comprises a starting sequence number.

9. A computer program product comprising a computer readable storage structure embodying computer program code thereon for execution by a computer processor, wherein said computer program code comprises instructions for performing a method comprising:
including acknowledgement information in a data transfer block, and
encoding the acknowledgement information independently of at least part of the data transfer block.

10. The computer program product according to claim 9, wherein the acknowledgement information comprises a variable length acknowledgement bitmap.

11. An apparatus, comprising:
a module configured to include acknowledgement information in a data transfer block; and
a modulator configured to encode the acknowledgement information independently of the data transfer block.

12. The apparatus according to claim 11, wherein the acknowledgement information comprises a variable length acknowledgement bitmap.

13. The apparatus according to claim 11, wherein the data transfer block comprises at least one data block.

14. The apparatus according to claim 11, wherein the data transfer block comprises a header comprising protocol information.

15. The apparatus according to claim 14, wherein the-header indicates the acknowledgement information is included in the data transfer block.

16. The apparatus according to claim 14, wherein the header indicates the length of the acknowledgement information.

17. The apparatus according to claim 11, wherein the acknowledgement information comprises an address identifying a temporary block flow to which the acknowledgement information is related.

18. The apparatus according to claim 11, wherein the acknowledgement information comprises a starting sequence number.

19. An apparatus, comprising:
means for including acknowledgement information in a data transfer block; and
means for encoding the acknowledgement information independently of the data transfer block.

20. The apparatus according to claim 19, wherein the acknowledgement information comprises a variable length acknowledgement bitmap.

21. A system, comprising:
a transmitting entity; and
a receiving entity;
wherein the transmitting entity comprises a module for including acknowledgement information in a data transfer block for transmission to the receiving entity;
wherein the transmitting entity comprises a modulator for encoding the acknowledgement information independently of the data transfer block.

22. The system according to claim 21, wherein the acknowledgement information comprises a variable length acknowledgement bitmap.

23. The system according to claim 21, wherein the data transfer block comprises at least one data block.

24. The system according to claim 21, wherein the data transfer block comprises a header comprising protocol information.
